(19) United States
(12) Patent Application Publication
(10) Pub. No.: US 2003/0141101 A1
(43) Pub. Date: Jul. 31, 2003

(54) Solid electric wire and its manufacturing method and apparatus

(75) Inventors: Hiroshi Mima, Jouyou-shi (JP); Yasuo Okuyama, Otsu-shi (JP); Yasunori Hatakeyama, Rittou-shi (JP); Tadashi Uozumi, Kyoto-shi (JP)

Correspondence Address: ARMSTRONG,WESTERMAN & HATTORI, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/352,929

(22) Filed: Jan. 29, 2003

(30) Foreign Application Priority Data
Jan. 31, 2002 (JP) 2002-023221

(51) Int. Cl. H01B 5/08

(52) U.S. Cl. 174/128.1

(57) ABSTRACT

The present invention provides a solid electric wire having a small resistance value and a low resistance increase rate at high frequency. A solid electric wire T has a structure in which a plurality of unit wires S are regularly confounded. Each of the unit wires S repeatedly extends inside and outside the electric wire, with a twist direction changed on the basis of a predetermined period. Accordingly, all or most of the unit wires cross each other, and a very large number of cross points are thus created. This reduces the effects of magnetic lines of force on the interaction between the unit wires. This in turn reduces a value for resistance to a high frequency current and the rate of increase in resistance associated with an increase in frequency. Moreover, the regular confounding structure of the unit wires advantageously leads to stable quality.

### FIELD OF THE INVENTION

The present invention relates to a technique of manufacturing a solid electric wire having a solid interior and a very large number of cross points by confounding a plurality of unit wires on the basis of the principle of braids. In the specification, the term “unit wire” refers not only to a solid wire but also to a twisted wire obtained by twisting a plurality of solid wires.

### BACKGROUND OF THE INVENTION

Electric wires are roughly classified into solid wires each consisting of a single conductor and twisted wires each obtained by twisting a plurality of unit wires together. The twisted wire is advantageous in that it is easier to bend than the solid wire and that its sectional dimensions can be adjusted easily by changing the number of unit wires twisted together. Conventionally known twisted wires include Litz wires, buncher wires, and ribbon wires.

In general, if an electric wire is used as a transmission line for high frequency current, a current resistance value disadvantageously increases consistently with frequency. However, with a twisted wire, the resistance value can be varied by changing a manner of twisting unit wires, even if the number of unit wires remains unchanged.

### SUMMARY OF THE INVENTION

It is an object of the present invention to provide an electric wire formed by twisting a plurality of unit wires together, the electric wire being structured to have a small alternating current (AC) conductor resistance value particularly in a high frequency region and to have a low rate of increase in resistance associated with an increase in frequency.

According to the present invention, there is provided a solid electric wire manufactured by confounding a plurality of unit wires together, the solid electric wire being characterized by being formed by confounding the unit wires together so that each of the unit wires repeatedly extends through an interior of the electric wire and then on a surface portion of the electric wire.

With such a configuration, the solid electric wire of the present invention has a reduced resistance value in a high frequency region and a reduced rate of increase in resistance associated with an increase in frequency. The details of the reason for this are not clear but may be inferred as described below. A solid electric wire having the above configuration is constructed by confounding the unit wires together so that each of the unit wires repeatedly extends through the interior of the electric wire and then on its surface portion. Accordingly, all or most of the unit wires cross one another. Currents induced in the crossing unit wires by external magnetic lines of force flow in different directions. Consequently, amplification is precluded. Further, the induced currents may flow in the opposite directions depending on the angle at which the unit wires cross each other. In this case, the currents cancel each other. The solid electric wire of the present invention is structured to have a very large number of cross points. This reduces the effects of magnetic lines of force on the interaction between the unit wires. This is assumed to be why a value for resistance to a high frequency current is reduced and why the rate of increase in resistance associated with an increase in frequency is maintained at a low value.

On the other hand, the conventional twisted wire has a smaller number of cross points even if the same number of unit wires are used. Further, the adjacent unit wires in the conventional twisted wire are likely to be affected by magnetic force. Consequently, the conventional twisted wire does not serve to reduce the value for resistance to a high frequency current or the rate of increase in resistance.

Further, the present invention provides a method of manufacturing the above solid electric wire. That is, the present invention provides a method of manufacturing a solid electric wire by confounding a plurality of unit wires together by moving a plurality of bobbins around each of which a unit wire has been wound, along a predetermined track while drawing out the unit wire from each bobbins the method being characterized in that a plurality of bobbin carriers holding the bobbins are arranged on a track plate in which a guide groove is formed so that the bobbin carriers form a plurality of rows, and interference among the bobbin carriers is avoided by moving the bobbin carriers on a predetermined path along the guide groove in the track plate, and in the middle of a moving step, performing an operation of delaying movement of each of the bobbin carriers at a particular point of the guide groove.

Furthermore, the present invention provides an apparatus of manufacturing the above solid electric wire. That is, the present invention provides an apparatus that manufactures a solid electric wire by confounding a plurality of unit wires together, the apparatus being characterized by comprising bobbin carriers each holding a bobbin around which the unit wire has been wound, a plurality of vane wheels each having a plurality of slits into one of which a guide section of the corresponding bobbin carrier is inserted, the vane wheels being arranged so as to rotate synchronously, and a track plate in which a guide groove is formed to set a movement path for the bobbin carriers arranged on the vane wheels, and in that the bobbin carrier inserted into one of the slits in the corresponding vane wheel moves on a predetermined path along the guide groove in the track plate while being delivered from one of the vane wheels to another, and in that the apparatus includes slit shifting means for performing an operation on particular vane wheels, the operation comprising retreating the bobbin carrier from the slot in the corresponding vane wheel and then inserting the bobbin carrier into the adjacent slit in the same vane wheel.

According to this manufacturing method and apparatus, the movement of the bobbin carriers is delayed at the particular point of the guide groove. Accordingly, the bobbin carriers can move along the predetermined path without interfering with one another even if they are densely arranged. This enables the mechanized manufacture of a solid electric wire structured to have a very large number of cross points. The mechanization allows the quality of the product to be stabilized easily. In the prior art, if the bobbin carriers are densely arranged, no appropriate means are available for moving the bobbin carriers without causing them to interfere with one another. It has thus been very difficult to mechanize the manufacture of a solid electric wire composed of densely confounded unit wires.

### BRIEF DESCRIPTION OF THE DRAWINGS

FIG. 1 is a perspective view showing an embodiment of a solid electric wire according to the present invention, wherein a part of the solid electric wire is viewed from its front.

FIG. 2 is a transverse sectional view showing an embodiment of a solid electric wire according to the present invention, wherein the solid electric wire is viewed along a direction perpendicular to a longitudinal direction.

FIG. 3 is a perspective view showing an embodiment of a manufacturing apparatus for a solid electric wire according to the present invention.

FIG. 4 is a front view showing a bobbin carrier in the above embodiment of the manufacturing apparatus for a solid electric wire according to the present invention.

FIG. 5 is a front view showing a track plate in the above embodiment of the manufacturing apparatus for a solid electric wire according to the present invention.

FIG. 6 is a partly enlarged front view showing the relationship between the bobbin carrier and the track plate in the above embodiment of the manufacturing apparatus for a solid electric wire according to the present invention.

FIGS. 7A and 7B are front views showing two movement paths for the bobbin carrier on the track plate in the above embodiment of the manufacturing apparatus for a solid electric wire according to the present invention.

FIG. 8 is a front view showing vane wheels and pushers in the above embodiment of the manufacturing apparatus for a solid electric wire according to the present invention.

FIG. 9 is a front view showing an example of arrangement of vane wheels in the above embodiment of the manufacturing apparatus for a solid electric wire according to the present invention.

FIG. 10 is a schematic diagram showing an example of arrangement of vane wheels in the manufacturing apparatus for a solid electric wire according to the present invention.

FIG. 11 is a front view showing a start state of slit shifting operation of a manufacturing method for a solid electric wire according to the present invention.

FIG. 12 is a front view showing a state in the slit shifting operation of a manufacturing method for a solid electric wire according to the present invention, wherein a guide section of the bobbin carrier is retreated from a slit in the vane wheel.

FIG. 13 is a front view showing a situation in the slit shifting operation of a manufacturing method for a solid electric wire according to the present invention, wherein the state is maintained in which the guide section of the bobbin carrier is retreated from the slit in the vane wheel.

FIG. 14 is a front view showing a state in the slit shifting operation of a manufacturing method for a solid electric wire according to the present invention, wherein the guide section of the bobbin carrier is inserted into the next slit in the vane wheel.

FIG. 15 is a front view showing a state in the slit shifting operation of a manufacturing method for a solid electric wire according to the present invention, wherein movement of bobbin carrier is restarted after its guide section has been inserted into the next slit in the vane wheel.

FIG. 16 is a front view of the track plate, showing a movement path for the bobbin carrier according to the above embodiment of the manufacturing apparatus for a solid electric wire.

FIG. 17 is a front view of the track plate, showing a former half of the movement path for the bobbin carrier according to the above embodiment of the manufacturing apparatus for a solid electric wire.

FIG. 18 is a front view of the track plate, showing the rest of the movement path for the bobbin carrier according to the above embodiment of the manufacturing apparatus for a solid electric wire.

FIG. 19 is a graph showing the results of tests in which the rate of increase in resistance at high frequency was measured for a solid electric wire of the present invention were measured for.

FIG. 20 is a table showing measured values for the rate of increase in resistance at high frequency for the solid electric wire of the present invention.

FIG. 21 is a graph showing the results of tests in which the rate of increase in resistance at high frequency was measured for solid electric wires of different braiding densities according to the present invention.

FIG. 22 is a chart showing measured values for the rate of increase in resistance at high frequency for the solid electric wires of different braiding densities according to the present invention.

### DETAILED DESCRIPTION OF THE PREFERRED EMBODIMENTS

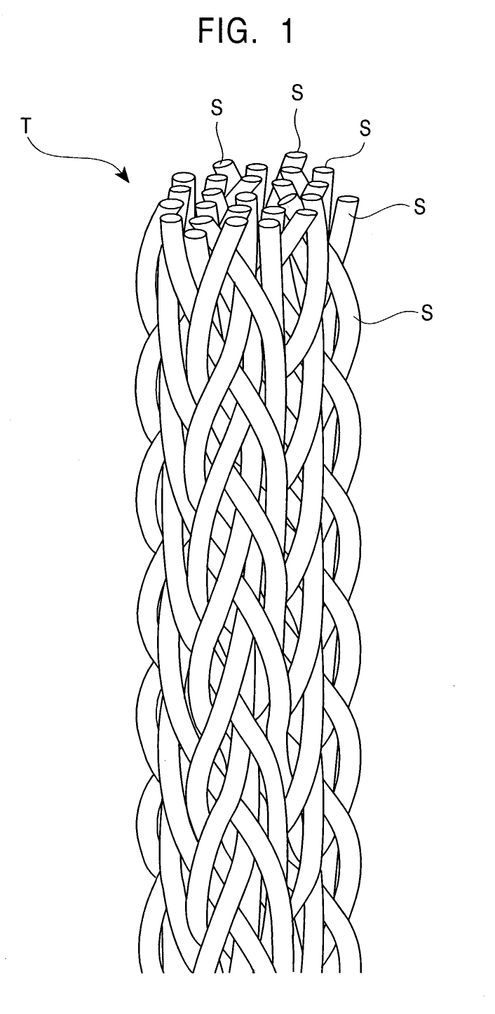

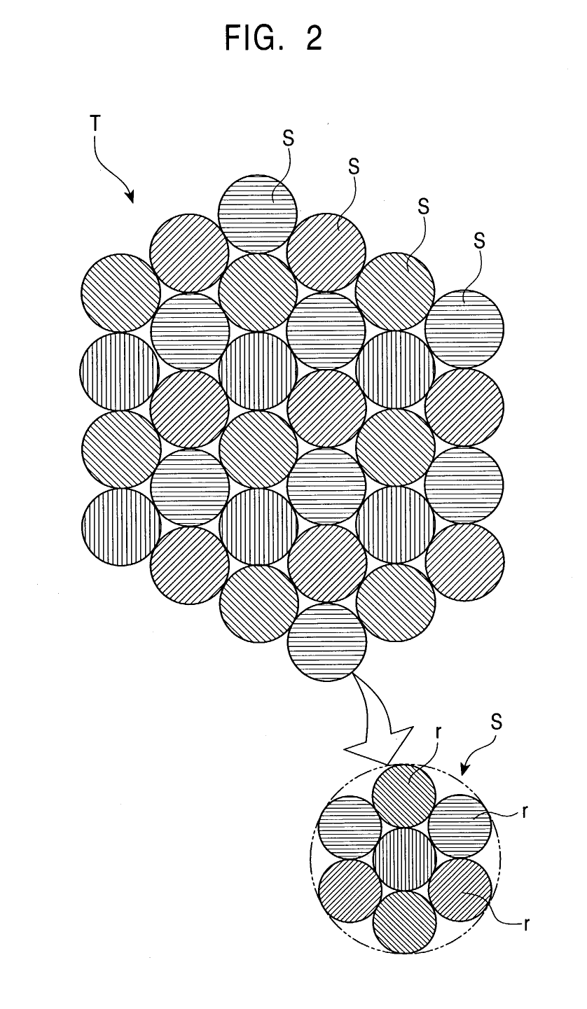

FIGS. 1 and 2 show an embodiment of a solid electric wire T according to the present invention. FIG. 1 is a perspective view of a part of the solid electric wire as viewed from its front. FIG. 2 is a transverse sectional view of the solid electric wire as viewed along a direction perpendicular to its longitudinal direction. In these drawings, gaps shown among unit wires S in order to make the confounding structure of the unit wires S understood easily. However, the unit wires S contact tightly with one another, and the gaps are very small. Further, the surface of the solid electric wire is normally coated with appropriate material for use.

The solid electric wire of the present invention is characterized in that a plurality of unit wires S are densely confounded together to significantly increase the number of points at which the unit wires S cross each other. The diameter and number of unit wires S can be arbitrarily set according to the application of the solid electric wire T, the situation of the manufacturing facility, or the like. Each of the unit wires S may be a solid wire consisting of a single conductor or a twisted wire obtained by twisting a plurality of solid wires r together as shown in FIG. 2. In the latter case, the number of solid wires twisted together may be properly selected. For example, three, six, or nine solid wires may be used. Furthermore, the material for the unit wire S is not particularly limited. Copper or copper alloy, aluminum or aluminum alloy, or other known electric wire materials can be used.

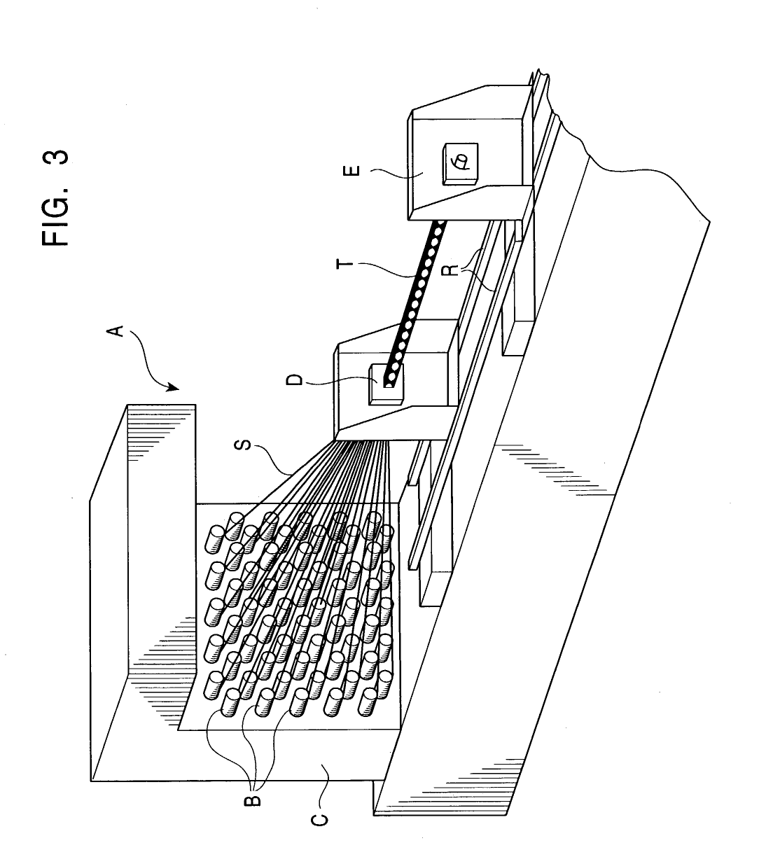

FIG. 3 shows an example of an apparatus A used to manufacture the solid electric wire T according to the present invention. The apparatus A is configured so that a large number of bobbins B are arranged on an apparatus body section C so as to move along a predetermined path. Further, in the apparatus A, the unit wires S drawn out from the corresponding bobbins B are passed through a frame D and then drawn up by traction means E that is movable on rails R. Accordingly, each of the bobbins B is moved along the predetermined path, and the traction device E draws up the unit wires S passed through the frame D. Then, the unit wires S are confounded to allow the manufacture of a solid electric wire T having a desired three-dimensional structure and a desired sectional shape.

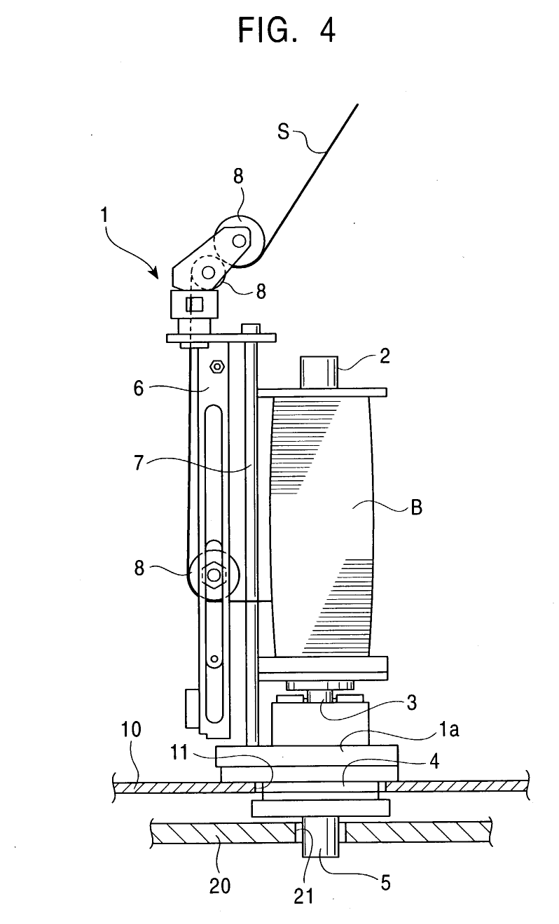

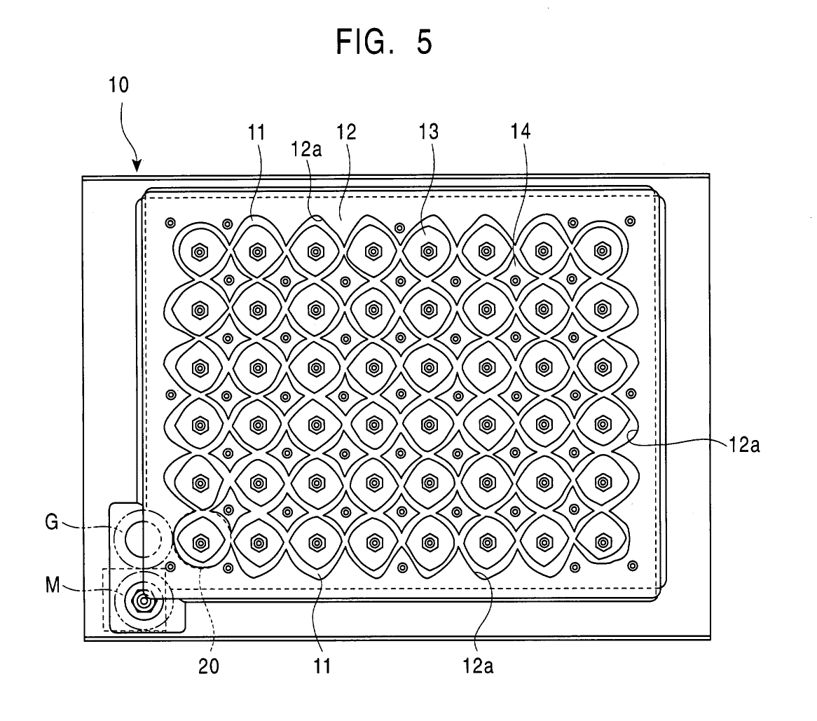

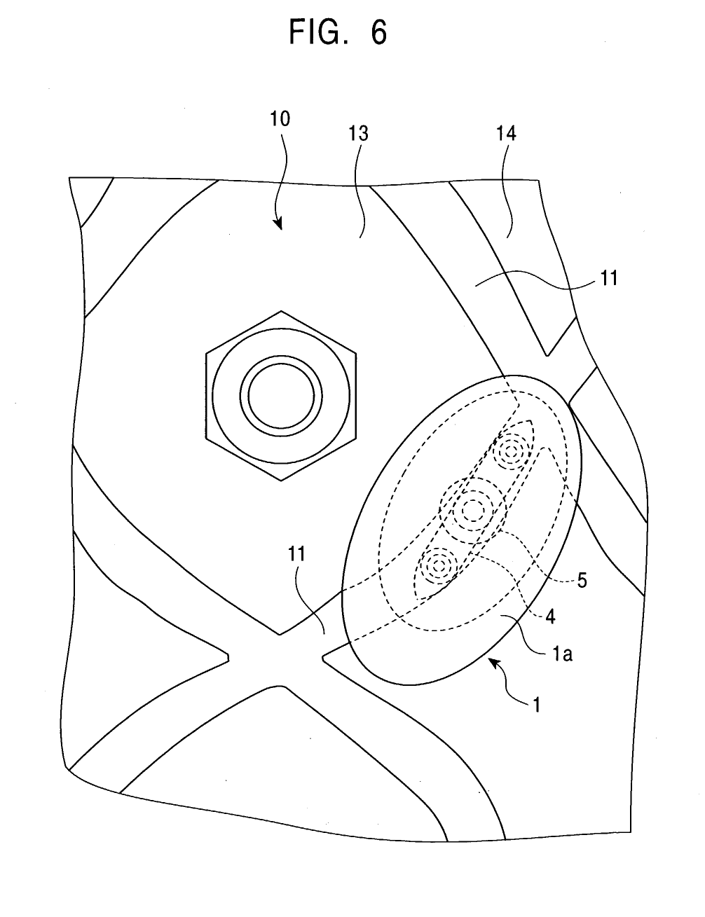

According to the present invention, the means described below is employed to move the large number of bobbins B arranged two-dimensionally in a vertical and horizontal directions without causing them to interfere with one another. The bobbins B are each held by a bobbin carrier 1 as shown in FIG. 4 and is moved along a guide groove 11 in a track plate 10 as shown in FIG. 5. The bobbin carrier 1 is roughly composed of a holder section 2 provided with a shaft 3 that rotatably supports the bobbin Brand a guide section 6 that guides a draw-out direction of the unit wire S rewound from the bobbin B, using a number of guide rollers 8. The guide section 6 can be rotationally moved properly by a shaft 7 provided on a base section 1a so as to extend vertically. A slider section 4 and a guide section 5 that faces a lower end surface are provided under the base section 1a. The slider section 4 is fitted into the guide groove 11 in the track plate 10 and has, for example, an elongated planar shape with pointed opposite ends as shown in FIG. 6. On the other hand, the guide section 5 is inserted into a slit 21 in an vane wheel 20, described later, so as to advance and retreat freely. The guide section 5 is formed to be cylindrical as illustrated in FIG. 6.

FIG. 5 shows an example of the track plate 10 in which the guide groove 11 is formed, and the slider section 4 of the bobbin carrier 4 is fitted into the guide groove 11. In the track plate 10, notches 12a of a predetermined shape are formed in a base plate 12. The predetermined guide groove 11 is then formed by fixing a large number of groove forming plates 13, 14 in the respective notches 12a at intervals using bolts and nuts.

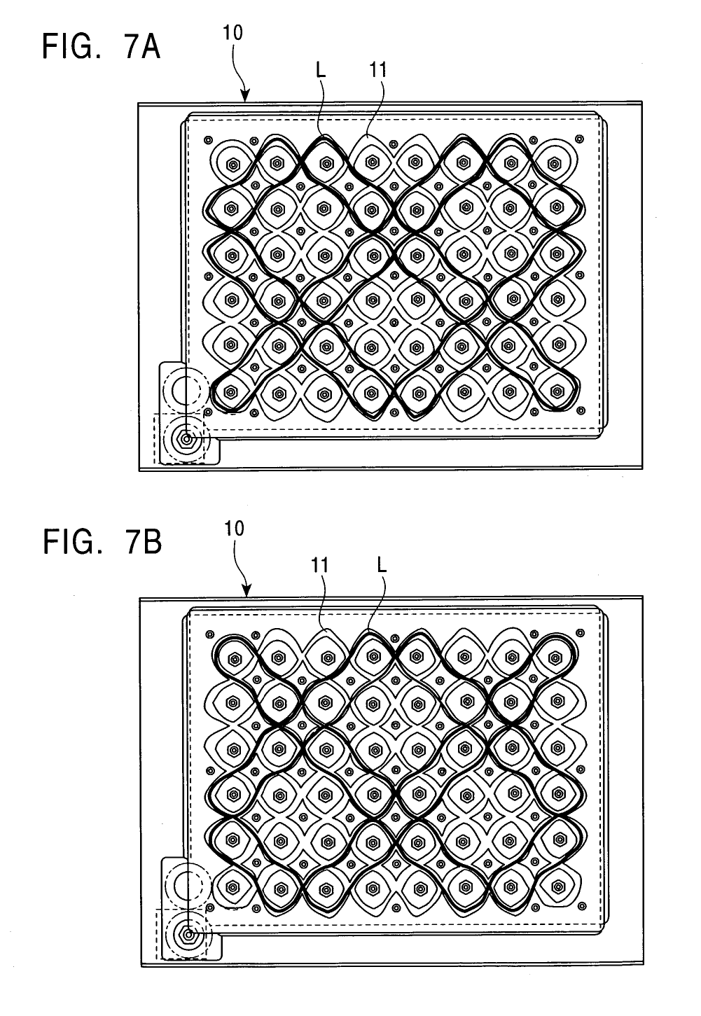

As shown in FIG. 6, the slider section 4 of the bobbin carrier 1 is fitted into the guide groove 11. Thus, when the vane wheel described later is used to apply urging force to the bobbin carrier 1 through the guide section 5, movement of the bobbin carrier 1 is restricted to a direction in which the slider section 4 can slide while abutting against the guide grooves 11. Accordingly, by properly setting the form of the guide groove 11, a desired movement path is established for the bobbin carriers 1. With the track plate 10 shown in FIG. 5, two types of movement paths L, shown in FIG. 7A and FIG. 7B by solid lines, are set for the bobbin carriers 1.

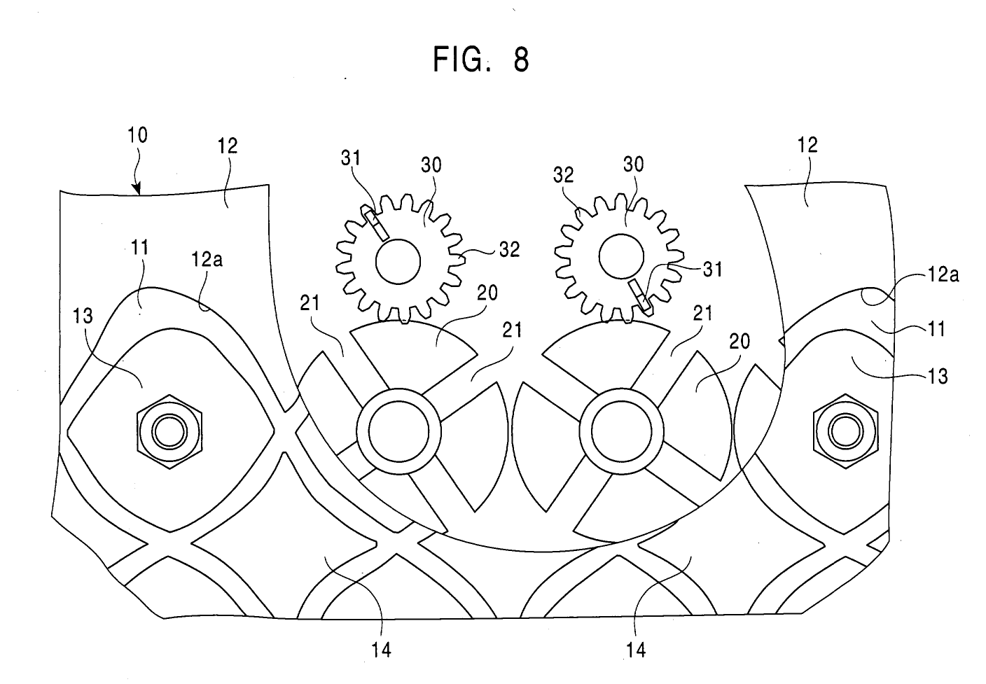

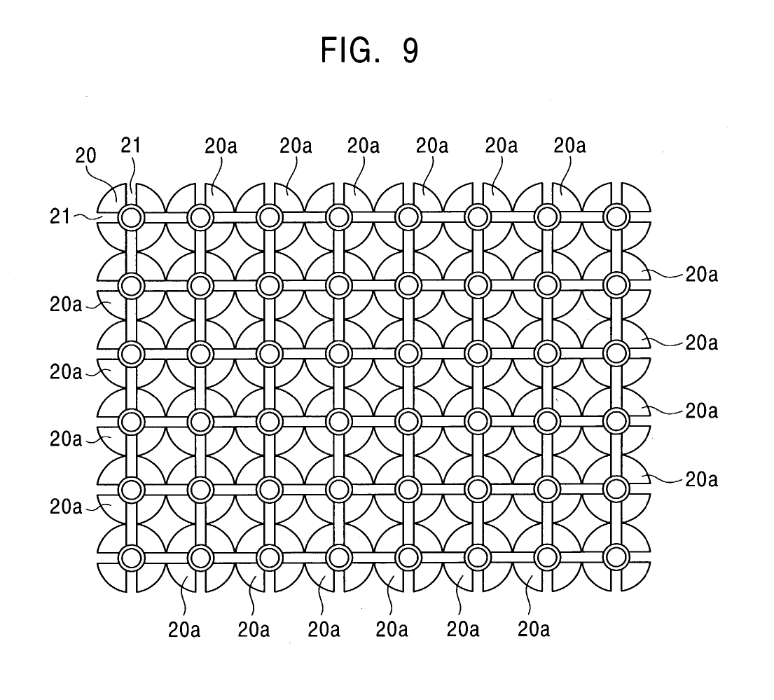

As shown in FIG. 8, the following two components are disposed on a back surface of the track plate 10, that is, the vane wheels 20 each of which exerts urging force to move the corresponding bobbin carrier 1, and pushers 30 each of which pushes the corresponding bobbin carrier 1 retreated from a slit 21 in the corresponding vane wheel 20, into the adjacent slit 21. The vane wheel 20 is provided parallel with the track plate 10 so as to correspond to the groove forming plate 13 in the track plate 10. In the track plate 10 shown in FIG. 5, the vane wheels 20 are placed in a 6×8 (length×breadth) arrangement as illustrated in FIG. 9. In the present example, each vane wheel 20 has four slits 21. The adjacent vane wheels 20 are engaged with each other using a gear or the like so that all vane wheels 20 rotate synchronously. As shown in FIG. 5, a motor M is installed at an appropriate location and connected directly to the vane wheels 20 or via a speed reducer G. Then, all vane wheels 20 can be driven rotationally.

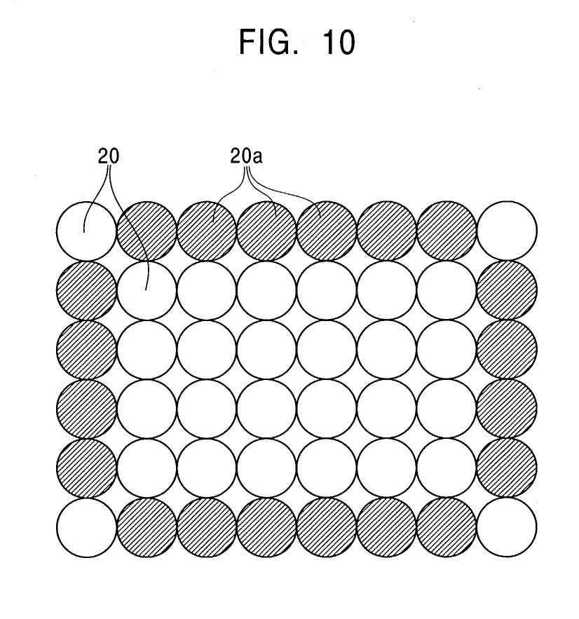

The pusher 30 is composed of a gear 32 joined to the corresponding vane wheel 20 for synchronous rotation and provided with a pushing section 31 that can abut against the guide section 5 of the corresponding bobbin carrier 1. The pusher 30 is mounted at a position corresponding to the particular vane wheel 20. Specifically, the pushers 30 are attached to those vane wheels 20 to each of which an odd number of other vane wheels 20 are adjacent. For example, if the vane wheels 20 are arranged as shown in FIG. 9, the pushers 30 are attached to the vane wheels 20a arranged in the outer periphery except those located in the four corners, as shown hatched in FIG. 10.

The slider section 4, provided at the base section 1a of the bobbin carrier 1, is fitted into the guide groove 11 in the track plate 10. Further, the guide section 5 is inserted into the slit 21 in the vane wheel 20 (see FIG. 4). Then, when the vane wheel 20 is rotationally driven, urging force is exerted through the guide section 5. Consequently, the bobbin carrier 1 can be moved on a predetermined path along the guide groove 11 while being delivered from one of the vane wheels 20 to another. Thus, the plurality of bobbin carriers 1 are disposed on the track plate 1, and each bobbin carrier 1 is moved as described above while drawing the unit wire S out from the bobbin B held on the bobbin carrier 1. As a result, the large number of unit wires S can be confounded together to allow the manufacture of a three-dimensional solid electric wire T.

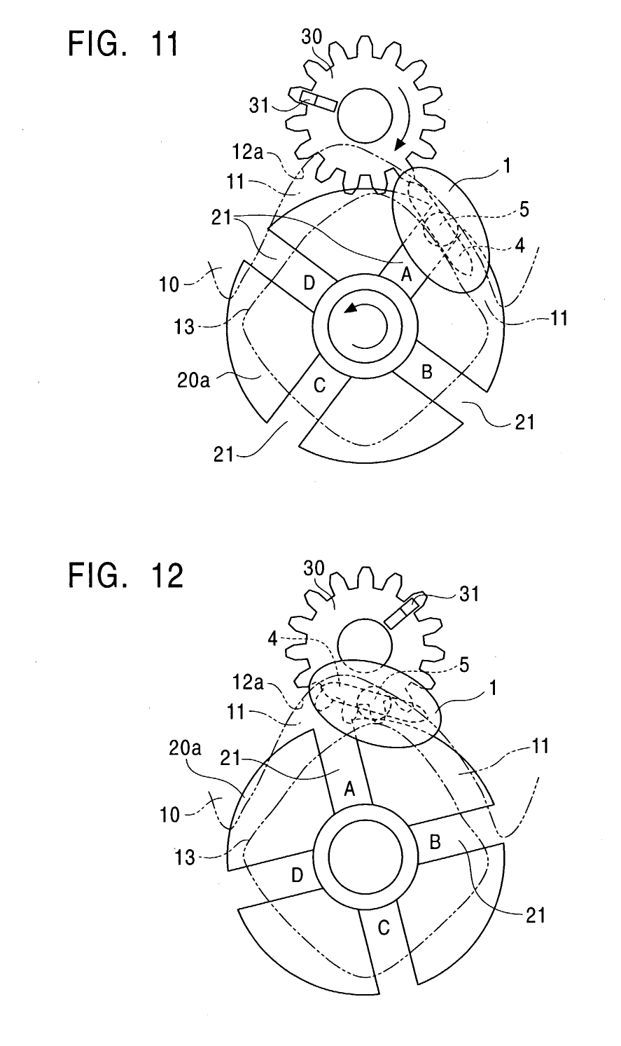

However, if a two-dimensional path is used in which the bobbin carrier 1 moves across plural rows of vane wheels 20 as in the present example, when the number of bobbin carriers 1 used is increased to improve the confounding density of the solid electric wire T, the bobbin carriers 1 may interfere with one another if all vane wheels 20 have the same number flutes (slits). Thus, in the present example, for the particular vane wheels 20, movement timing for the bobbin carrier 1 is delayed a period corresponding to one slit to avoid causing the bobbin carriers 1 to interfere with one another. This operation will be described with reference to FIG. 11 to FIG. 15. For the convenience of description, the four slits 21 in the vane wheel 20a are labeled A to D.

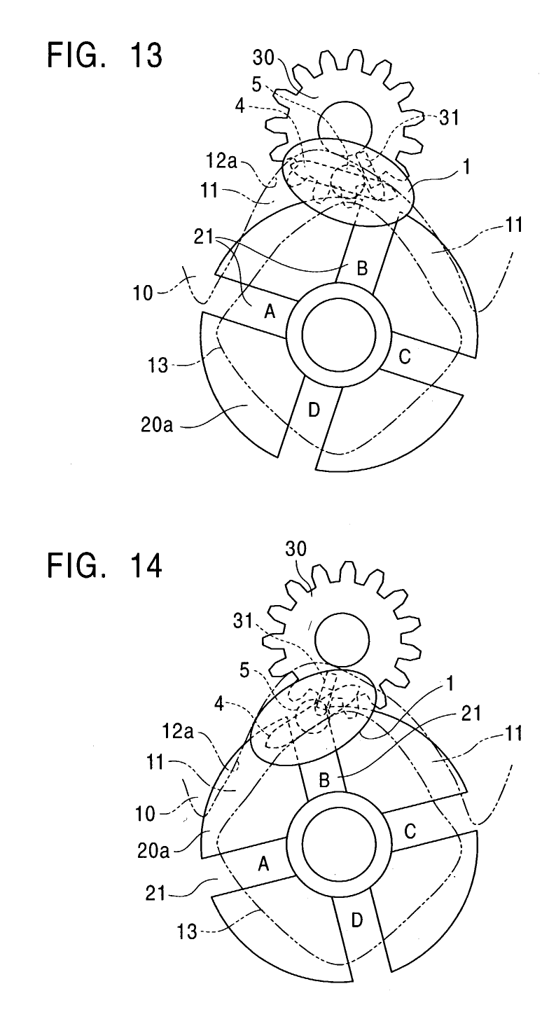

This operation is performed by the vane wheel 20a to which the pusher 30 is attached. As shown in FIG. 11, the guide section 5 of the bobbin carrier 1 is inserted into a slit A in the vane wheel 20a. Then, the vane wheel 20a rotationally drives the bobbin carrier 1 so as to move along the guide groove 11 in the track plate 10. The guide groove 11, formed by the base plate notch 12a and groove forming plate 13 in the track plate 10, is formed to push out the guide section 5 from the slit A in the vane wheel 20a as the bobbin carrier 1 moves. Thus, when the bobbin carrier 1 moves to the position shown in FIG. 12, the guide section 5 slips out of the slit A. Thus, the bobbin carrier 1 no longer undergoes urging force from the vane wheel 20a.

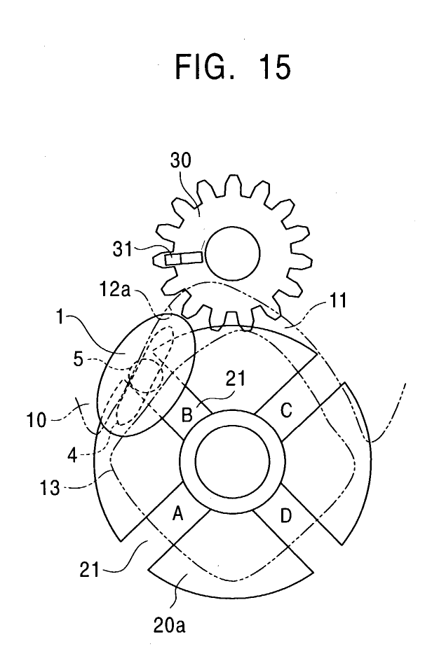

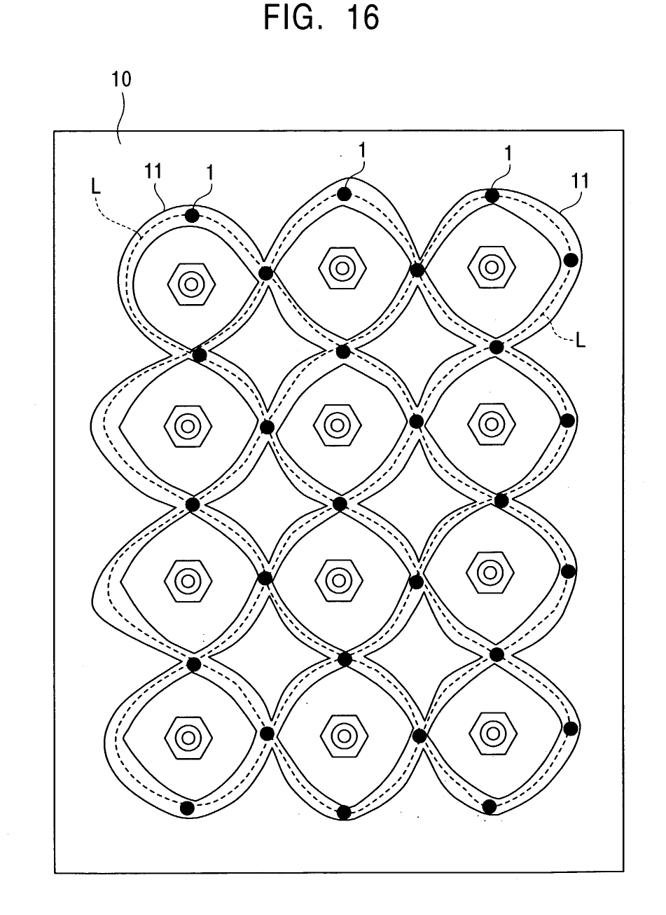

The state in which the bobbin carrier 1 retreats from the vane wheel 20a and is not urged by it is maintained until the next slit B approaches the bobbin carrier 1 as the vane wheel 20a rotates. As shown in FIG. 13, simultaneously with the approach of the slit B, the pushing section 31 of the pusher 30, which rotates synchronously with the vane wheel 20a, reaches the position at which it abuts the guide section 5 of the bobbin carrier 1. Then, as shown in FIG. 14, the vane wheel 20a and the pusher 30 further rotate to cause the pushing section 31 to exert pushing force on the guide section 5. Thus, the guide section 5 is pushed into the slit B in the vane wheel 20a. As a result, the bobbin carrier 1 receives urging force from the rotating vane wheel 20a and restarts movement along the guide groove 11 as shown in FIG. 15.

Thus, the manufacturing apparatus A of the present example shifts the slit 21 in the vane wheel 20 into which the guide section 5 of the bobbin carrier 1 is fitted, to the next one at a particular locations on the movement path for the bobbin carrier 1. This delays the movement timing for the bobbin carrier 1 a period corresponding to one slit. Therefore, if a large number of bobbin carriers 1 are arranged, they are prevented from interfering with one another.

In the manufacturing apparatus A, the pushers 30 as slit shifting means are attached to all vane wheels 20a to each of which an odd number of other vane wheels 20 are adjacent so as to maximize the number of bobbin carriers 1 that can be arranged without interfering with one another. Then, the density of a manufactured solid electric wire can be maximized. The results of the inventors' study indicate that if the vane wheel 20 has four slits and the pushers 30 are attached to all vane wheels 20a to each of which an odd number of other vane wheels 20 are adjacent, then the maximum number M of bobbin carriers 1 that can be arranged without interfering with one another is given by M=(number of vane wheels×2)+(number of pushers×0.5). Specifically, if the vane wheels 20 each having four slits are placed in a 6×8 (length×breadth) arrangement as shown in FIG. 9 and the pushers 30 are attached to all of the 20 vane wheels 20a to each of which an odd number of other vane wheels 20 are adjacent, as shown hatched in FIG. 10, then the maximum number M of bobbin carriers 1 that can be arranged without interfering with one another is 48×2+20×0.5=106, on the basis of the above equation.

It is contemplated that depending on the purpose of the solid electric wire T to be manufactured, unit wires S with a small confounding density may not create any problems. In such a case, the number of bobbin carriers 1 disposed need not necessarily be maximized. Furthermore, when the number of bobbin carriers 1 disposed is reduced, it may be possible to omit some of the pushers 30 (slit shifting means) attached to the vane wheels 20a.

Discussion will follow on the reason why the solid electric wire T according to the present invention enables the formation of a confounded structure in which the unit wires S have a very large number of cross points. If a track plate 10 such as the one shown in FIG. 16 is used to place the vane wheels 20 in a 4×3 (length×breadth) arrangement, then the maximum number M of bobbin carriers 1 that can be arranged without interfering with one another is 12×2+6×0.5=27, on the basis of the above equation. Accordingly, the bobbin carriers 1 are arranged in the guide groove 11 in the track plate 10, for example, at positions shown by black circles. Each bobbin carrier 1 moves on the path L shown by the dashed line in the drawing, along the guide groove 11 in the track plate 10.

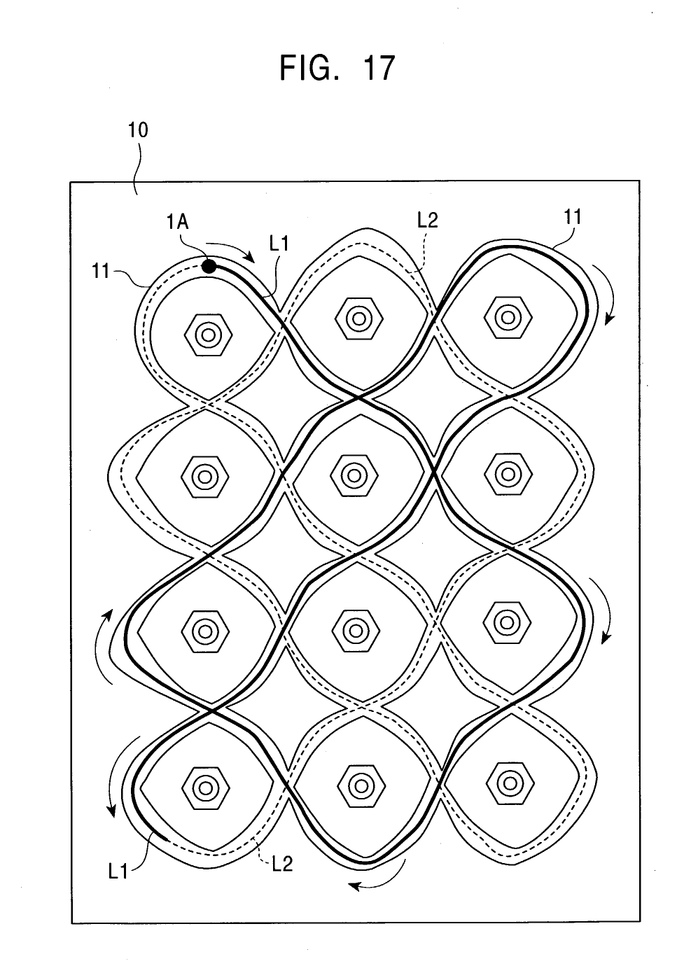

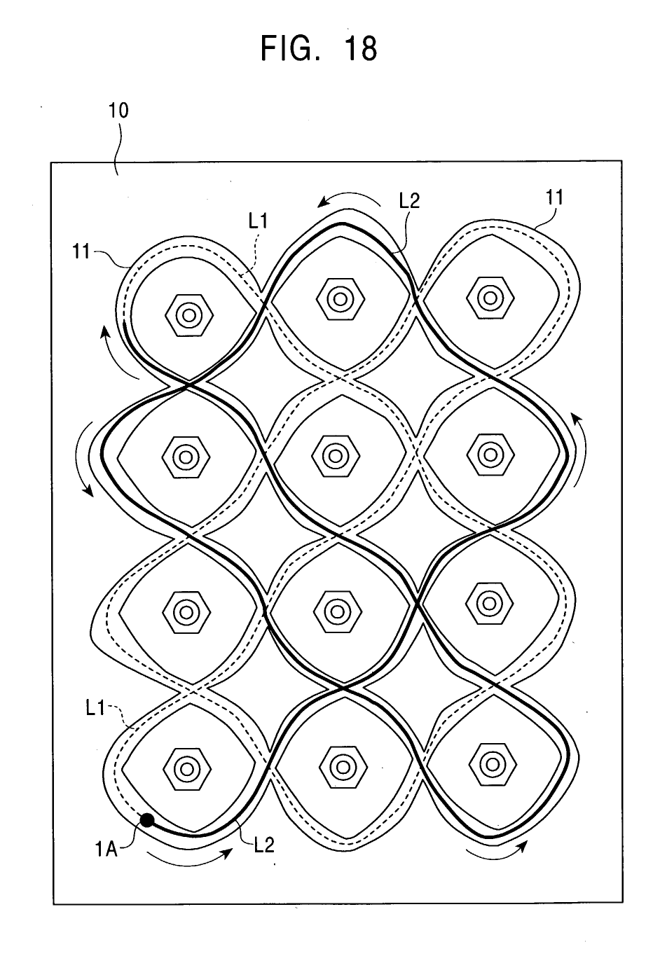

In this case, a particular bobbin carrier 1A is focused on. It is assumed that the bobbin carrier 1A moves on the movement path L shown in FIG. 17, in the direction shown by the arrows in the figure. The movement path L for the bobbin carrier 1A is configured to cross itself a large number of times between its start and end points. Furthermore, this movement path L is set to repeatedly extend inside and then outside. It is also set so that the direction in which the unit wires S are twisted is reversed between a former half L1 shown by the solid line in FIG. 17 and a latter half L2 shown by the solid line in FIG. 18 and following the former half L1.

When the bobbin carrier 1A crosses the movement path L, the unit wire S drawn out from the bobbin B installed on this bobbin carrier 1A crosses the unit wire S drawn out from the bobbin B on another bobbin carrier 1. In the present example, the movement path L for the bobbin carrier 1 is configured to cross itself a very large number of times and repeatedly extend inside and then outside. Thus, it is expected that a regular confounded structure in which the unit wires S have a large number of cross points is obtained by arranging a large number of bobbin carriers 1 and moving them along the predetermined movement path L without causing them to interfere with one another.

Furthermore, the movement path L is set so that while the bobbin carrier 1 is moving, the direction in which the unit wires S are twisted is changed. This is expected to be the reason why the direction of induced electromotive current generated in the unit wires S by external magnetic fields varies. This partly explains why an increase in resistance value at high frequency can be suppressed.

[Test 1]

The solid electric wire according to the present invention was compared with a conventional buncher wire (Litz wire) in terms of a change in AC resistance value associated with an increase in frequency. Two types of electric wires A and B composed of different unit wires were prepared as examples of the present invention.

An example A of the present invention was obtained by twisting three unit wires of diameter 0.12 mm together at a twist number of 66 T/M (twist/meter) to obtain a three-wire-twisted wire as a unit wire and manufacturing a solid electric wire using 116 unit wires and a manufacturing apparatus A such as the one shown illustrated in FIG. 3. An example B of the present invention was obtained by twisting six unit wires of diameter 0.12 mm together at a twist number of 49 T/M to obtain a six-wire-twisted wire as a unit wire and manufacturing a solid electric wire using 58 unit wires and the manufacturing apparatus A such as the one shown illustrated in FIG. 3. The total number of wires used in the example A was the same as that used in the example B. That is, 348 wires were used in both examples. Further, a traction device E (see FIG. 3) in the manufacturing apparatus A pulls both wires at the same speed. Accordingly, braiding density is substantially the same in both examples.

A buncher wire was prepared as a comparative example. First, six unit wires of diameter 0.12 mm and seven unit wires of diameter 0.12 mm were twisted respectively at a twist number of 66 T/M in an S twist direction. Three six-wire-twisted wires and three seven-wire-twisted wires, i.e. a total of six bundles were twisted together at a twist number of 49 T/M in a Z twist direction to obtain a bundle of 39 wires. Then, three bundles of 39 wires each were twisted together at a twist number of 40 T/M in the S twist direction to obtain a bundle of 117 wires. Furthermore, three bundles of 117 wires each were twisted together at a twist number of 33 T/M in the Z twist direction to obtain a bundle of 351 wires as a comparative example.

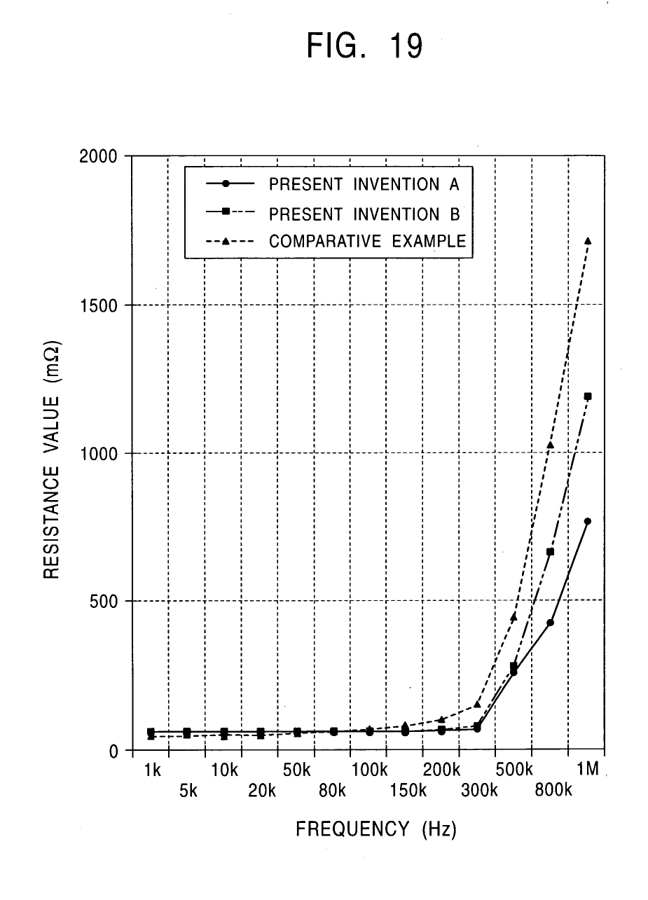

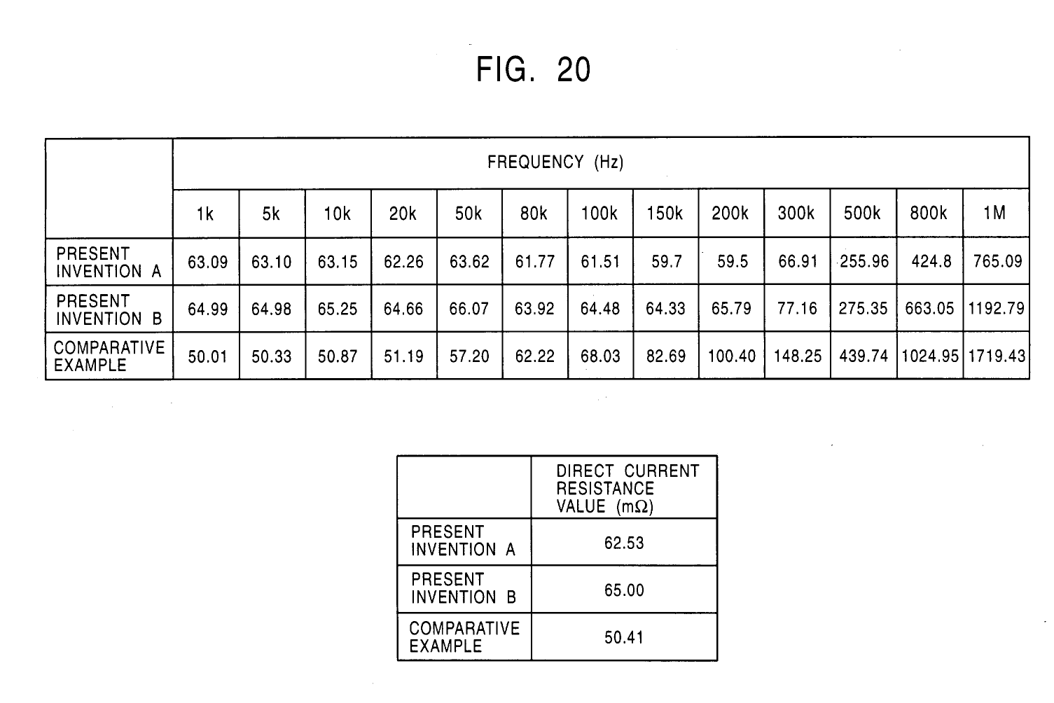

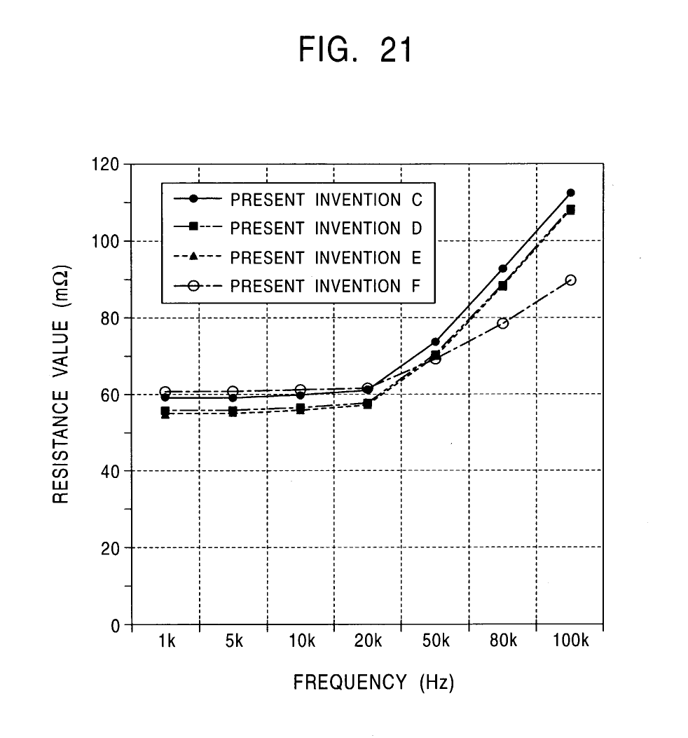

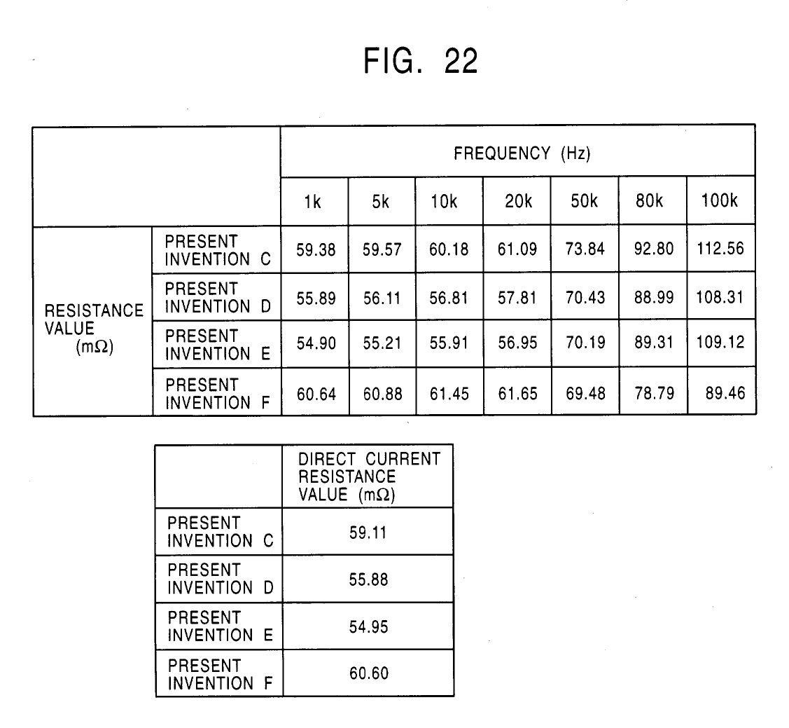

The examples A and B of the present invention and the comparative example obtained as described above were formed into coils of 10.5 m length, and current value was set so as to obtain a constant current of 10 mA. Then, resistance value was measured at a frequency between 1 kHz and 1 MHz. The results of the measurements are shown in the table in FIG. 19 and the graph in FIG. 20.

The results of the test evidently show that the solid electric wires according to the present invention have a smaller high-frequency resistance value and a smaller resistance increase rate than the comparative example though its direct current (DC) resistance value is larger than that of the comparative example. The results also indicate that even the characteristics of the present solid electric wire vary depending on the type of the unit wires.

[Test 2]

The inventors examined how the high-frequency current characteristic of the solid electric wire according to the present invention varies with braiding density even when the type and number of unit wires used remain unchanged. Two wires of diameter 0.2 mm were twisted together at a twist number of 77 T/M to obtain a two-wire-twisted wire as a unit wire. Then, four solid electric wires (C, D, E, and F) were manufactured by using 58 unit wires (a total number of 116 wires) and varying the traction speed of the traction device E of the manufacturing apparatus A, illustrated in FIG. 3. If the traction speed for the example C of the present invention during manufacture is defined as v, the traction speeds for the examples D, E, and F were about 1.25 v, 1.75 v, and 0.85 v, respectively. The braiding density increases with decreasing traction speed.

Measurements were carried out similarly to the test 1, described previously. The examples of the present invention obtained were formed into coils of 10.5 m length. The current value was set so as to obtain a constant current of 10 mA. Then, the resistance value was measured at a frequency between 1 kHz and 100 kHz. The results of the measurements are shown in the table in FIG. 19 and the graph in FIG. 20.

The results of the test evidently show that the solid electric wires according to the present invention have a decreasing resistance increase rate in a high frequency region with increasing braiding density even when the type and number of unit wires used remain unchanged and even if the DC resistance value increases. This is expected to be because in the solid electric wire of a high braiding density, the angle at which the unit wires cross each other is close to a right angle, thus reducing the effects of magnetic fields on the interaction between the unit wires.

In the description of the previously described embodiment, the track plate defining the movement path for the bobbins is shaped like a plate. However, the track plate may be formed into a curved surface. That is, the entire track plate or its track surface on which the bobbin carriers move is formed into a part of a spherical surface centered around the composition point at which the unit wires are confounded together to form a solid electric wire. In this case, the vane wheels are also arranged parallel with the curved track plate.

When the track surface of the track plate is in the form described previously, the distance from an arbitrary point on the track surface to the composition point at which a solid electric wire is formed is equal. As a result, the unit wire drawn out from each bobbin moving along the guide groove in the track plate is not bent between the bobbin and the composition point. Further, the distance from the bobbin to the composition point is constant whatever position on the movement path the bobbin is located at. This suppresses a variation in the tension of the unit wires. This in turn prevents the positional deviation of the unit wires or the like caused by a variation in the tension of the unit wires during a process of manufacturing a solid electric wire. Therefore, advantageously, high-quality solid electric wire can be manufactured.

The solid electric wire according to the present invention has a regular confounding structure in which unit wires have a large number of cross points. This solid electric wire is formed by confounding the unit wires together so that each of the unit wires repeatedly extends through an interior of the electric wire and then on a surface portion of the electric wire and so that for each unit wire. Further, rate at which the unit wire is located inside the electric wire is substantially equal to rate at which the unit wire is located on the surface portion. Furthermore, the unit wires are each twisted so that a twist direction is changed on the basis of a predetermined period.

Further, according to the manufacturing method of the present invention, the manufacture of a solid electric wire having the above configuration can be mechanized. Therefore, a solid electric wire having excellent characteristics can be provided inexpensively.

1. A solid electric wire manufactured by confounding a plurality of unit wires together, the wire being characterized by being formed by confounding the unit wires together so that each of the unit wires repeatedly extends through an interior of the electric wire and then on a surface portion of the electric wire.

2. A solid electric wire manufactured by confounding a plurality of unit wires together, the wire being characterized by being formed by confounding the unit wires together so that each of the unit wires repeatedly extends through an interior of the electric wire and then on a surface portion of the electric wire and so that for each unit wire, rate at which each unit wire is located inside the electric wire is substantially equal to rate at which the unit wire is located on the surface portion.

3. A solid electric wire manufactured by confounding a plurality of unit wires together, the wire being characterized in that the unit wires are twisted together so that each of the unit wires repeatedly extends through an interior of the electric wire and then on a surface portion of the electric wire and so that a twist direction is changed on the basis of a predetermined period.

4. A solid electric wire according to any one of claim 1 to claim 3, characterized in that an angle at which said unit wires cross each other is substantially a right angle.

5. A method of manufacturing a solid electric wire by confounding a plurality of unit wires together by moving a plurality of bobbins around each of which a unit wire has been wound, along a predetermined track while drawing out the unit wire from each bobbins the method being characterized in that a plurality of bobbin carriers holding said bobbins are arranged on a track plate in which a guide groove is formed so that the bobbin carriers form a plurality of rows, and interference among the bobbin carriers is avoided by moving said bobbin carriers on a predetermined path along the guide groove in the track plate, and in the middle of a moving step, performing an operation of delaying movement of each of the bobbin carriers at a particular point of the guide groove.

6. A solid electric wire manufacturing method according to claim 5, characterized in that the bobbin carriers are set to move on the predetermined path along the guide groove in the track plate by arranging a plurality of vane wheels under said track plate so as to rotate synchronously, inserting a guide section of each of the bobbins into one of slits formed in the corresponding vane wheel at a predetermined pitch, and rotating the vane wheels, and in that movement of each bobbin carrier is delayed by performing a slit shifting operation on particular vane wheels, the operation comprising retreating the bobbin carrier from the slot in the corresponding vane wheel and then inserting the bobbin carrier into the adjacent slit in the same vane wheel.

7. An apparatus that manufactures a solid electric wire by confounding a plurality of unit wires together, the apparatus being characterized by comprising bobbin carriers each holding a bobbin around which the unit wire has been wound, a plurality of vane wheels each having a plurality of slits into one of which a guide section of the corresponding bobbin carrier is inserted, the vane wheels being arranged so as to rotate synchronously, and a track plate in which a guide groove is formed to set a movement path for the bobbin carriers arranged on the vane wheels, and in that the bobbin carrier inserted into one of the slits in the corresponding vane wheel moves on a predetermined path along the guide groove in the track plate while being delivered from one of the vane wheels to another, and in that the apparatus includes slit shifting means for performing an operation on particular vane wheels, the operation comprising retreating the bobbin carrier from the slot in the corresponding vane wheel and then inserting the bobbin carrier into the adjacent slit in the same vane wheel.

8. A solid electric wire manufacturing apparatus according to claim 7, characterized in that said slit shifting means comprises a track plate set to push the bobbin carrier out of the slit in the corresponding particular vane wheel as the bobbin carrier moves and a pusher set to rotate synchronously with said particular vane wheel to push said bobbin carrier into the adjacent slit in said particular vane wheel.
